(19) United States
(12) Patent Application Publication
(10) Pub. No.: US 2014/0354436 A1
(43) Pub. Date: Dec. 4, 2014

(54) SYSTEMS AND METHODS FOR USING A HAND HYGIENE COMPLIANCE SYSTEM TO IMPROVE WORKFLOW

(71) Applicant: Proventix Systems, Inc., Birmingham, AL (US)

(72) Inventors: Harvey Allen Nix, Birmingham, AL (US); Kelly Dawn Cheatham, Maylene, AL (US); Greg Leo Neil, Birmingham, AL (US); Jane Durham Smith, Hoover, AL (US)

(73) Assignee: Proventix Systems, Inc., Birmingham, AL (US)

(21) Appl. No.: 14/463,621

(22) Filed: Aug. 19, 2014

Related U.S. Application Data
(63) Continuation-in-part of application No. 13/736,945, filed on Jan. 9, 2013.

(51) Int. Cl. G08B 21/24; G06F 3/0481; G06F 3/01; G06F 3/0484

(52) U.S. Cl. CPC G08B 21/245; G06F 3/0484; G06F 3/04817; G06F 3/017
USPC 340/573.1

(57) ABSTRACT

A hand hygiene compliance (HHC) system that, in addition to monitoring hand hygiene, provides messaging and asset tracking capabilities to improve workflow amongst employees working at a facility. In one embodiment, the HHC system includes a control unit associated with a hand hygiene dispenser and programmed to enable use of one or more icons each time the control unit detects use of the hand hygiene dispenser by an individual, wherein the icons allow the individual to, without limitation, enter or update a pain status indicator that is representative of a patient's response to a pain status inquiry event. More specifically, the icons are displayed on a feedback device associated with the control unit, and users select the icons by physically touching the feedback device. In alternative embodiments, the control unit includes a gesture sense system which allows users to select icons without touching the feedback device.

### CROSS REFERENCE TO RELATED APPLICATION

This application is a continuation-in-part (CIP) application that claims the benefit of and priority to, U.S. application Ser. No. 13/736,945 filed on Jan. 9, 2013.

### TECHNICAL FIELD

The present disclosure relates to a hand hygiene compliance (HHC) system that, in addition to monitoring hand hygiene, provides data entry and messaging capabilities that allow healthcare workers to optimize their workflow and, in the process, improve the level of care they provide to each of their patients. More specifically, the HHC system includes a control unit that is associated with a hand hygiene dispenser and configured to enable use of a touch or touch-free user interface each time the control unit detects a parameter indicating use of the dispenser by an individual, wherein icons on the user interface allow the individual to, without limitation, communicate, enter, or update patient care information.

### BACKGROUND

In 2002, the Centers for Medicare and Medicaid Services (CMS) asked the Agency for Healthcare Research and Quality (AHRQ) to develop a survey that measures a patient's perception of the level of care they received during their stay. The survey, which is now commonly referred to as the Hospital Consumer Assessment of Healthcare Providers and Systems (HCAHPS) survey, includes twenty-seven (27) questions and is used to publicly report hospital performance (quality of care as perceived by patients). As follows, consumers (that is, potential patients) may rely on public reports of hospital performance to select a hospital. Further, in order to avoid losing as much as two-percent (2%) of its Medicare/Medicaid reimbursement, hospitals must provide a patient with the HCAHPS survey at the time the patient is discharged.

Of the 27 questions included in the HCAHPS survey, a select number are related to pain management (that is, the frequency with which healthcare workers inquire about a patient's level of pain). Currently, when pain is assessed inside a patient's room, it s communicated in written form or called into a nurse's station. As such, since data related to pain management is not recorded electronically at the time of assessment, there exists a likelihood for said data to be forgotten or recorded incorrectly. This is problematic, because this data serves as the only check against HCAHPS scores, specifically pain management scores.

The issue of healthcare-associated infections (HAIs) is well known within and outside the healthcare community. To date, many studies have been conducted in an effort to ascertain effective ways to reduce the occurrence of HAIs, and the clear majority finds a thorough cleansing of one's hands upon entering and exiting a patient's room as the single most effective way to prevent the spread of HAIs. As a result, in an attempt to improve patient care, many hospitals have installed HHC systems to monitor healthcare workers' compliance with hand hygiene protocols. However, since HHC systems are limited to monitoring hand hygiene, which accounts for only one of a plurality of factors affecting patient care, the return-on-investment (ROI) for these systems has yet to be fully optimized.

Therefore, in order to improve documentation of pain management and other similar quality metrics encompassed in the HCAHPS survey, hospitals must implement different systems are needed to improve some or all of the many factors affecting patient care. Thus, there is a need for a system that combines the asset tracking capabilities of an RTLS system, the messaging capabilities of a nurse/call system, and the hand hygiene monitoring capabilities of a HHC system.

### SUMMARY

The present disclosure may address one or more of the problems and deficiencies discussed above. However, it is contemplated that the disclosure may prove useful in addressing other problems and deficiencies in a number of technical areas. Therefore, the present disclosure should not necessarily be construed as limited to addressing any of the particular problems or deficiencies discussed herein.

Embodiments of the present disclosure provide a HHC system that, in addition to monitoring hand hygiene, provides data entry, messaging, and asset tracking capabilities which allow healthcare workers to optimize their workflow, and, in the process, improve the quality of care they provide to each of their patients. In a preferred embodiment, the HHC system includes a communications network capable of detecting the presence of a person having a wearable tag, preferably in the form of a Radio Frequency Identification (RFID) tag, and monitors whether the person washed his hands upon entering and exiting a patient's room. The HHC system also includes a control unit (that is, a device equipped with a sensor and communications devices) which further includes a feedback device in the form of a display and necessary hardware to detect the wearable tag and communicate with a communications network, such as a wireless computer network. Through the communications network, the control unit may communicate with devices throughout the hospital, including, without limitation, servers, tablets, PDAs, cellular phones, desktop computers at an administrator's desk or nurses' station, or any other like device now existing or hereinafter developed.

The control unit is associated with a hand hygiene dispenser and is programmed to enable use of a touch or touch-free user interface each time the control unit detects a parameter indicating use of the hand hygiene dispenser by a person. In particular, icons displayed on the touch or touch-free user interface allow the person to, without limitation, communicate, enter, obtain, or update workflow information through the selection of one or more icon(s) displayed on the feedback device. In other words, the user interface cannot receive input unless and until the person complies with hand hygiene protocols by using the dispenser. Additionally, the term “icons” is used broadly to refer to a graphic or textual element displayed on the feedback device, the selection of which may execute a command, a macro, or cause new icons to be displayed on the feedback device.

In one embodiment, healthcare workers enter or update existing patient information by selecting one or more icons of a touch-screen user interface (TUI) displayed on the feedback device of a control unit. More specifically, upon detecting use of the hand hygiene dispenser by a healthcare worker wearing a tag, the control unit enables use of the TUI to allow the healthcare worker to enter or update existing patient information, such as without limitation, a pain status indicator for a patient. The control unit preferably is programmed to prohibit use of the TUI and its associated icons unless and until a person complies with hand hygiene protocols by using the dispenser. Thus, if a healthcare worker needs to access the TUI to perform a required task, then the healthcare worker must comply with hand hygiene protocols. Otherwise, the healthcare worker cannot perform her job.

In another embodiment, the user interface is touch-free and, while enabled, allows healthcare workers to select icons displayed on the feedback device without physically touching the display. More specifically, the control unit includes a gesture-sense system which includes a plurality of transmitters, a receiver, and a controller. The transmitters can be configured to transmit a light-based signal, a heat-based signal, or a sound-based signal. The receiver measures reflected signals from an object, such as a user's hand, over a predetermined amount of time to detect motion of the object. The controller is associated with the receiver and uses an algorithm to match motion of the object to one of a plurality of predefined gestures which may include, without limitation, a right swipe, left swipe, hover, or enter gesture. In the event the object's motion matches one of the predefined touch-free gestures, the controller executes an action in response to the gesture. As an example of an action, the controller may change the selection status of an icon by moving a selection indicator (which may be represented by highlighting the icon) left or right or directly to a particular icon, or may execute the command associated with the icon, which may cause the controller to perform a function, macro, or modify those icons currently displayed on the feedback device.

Further, in response to detecting one or more gestures, the control unit communicates data over the communications network to the server, wherein data may include, without limitation, the icon or sequence of icons selected. Upon receiving data, a processor associated with the server is programmed to execute instructions specific to data. Alternatively, in other embodiments, the control unit may include a processor that is programmed to execute instructions specific to data.

These and other embodiments of the present disclosure will become readily apparent to those skilled in the art from the following detailed description of the embodiments having reference to the attached figures, the disclosure not being limited to any particular embodiment(s) disclosed.

### BRIEF DESCRIPTION OF THE DRAWINGS

FIG. 1 is a block diagram illustrating one embodiment of a control unit associated with a HHC system in accordance with the present disclosure.

FIG. 2 is a diagram illustrating a method for processing information with the control unit of FIG. 1.

FIG. 3 depicts a pain status indicator being entered via a touch user interface displayed on the feedback device shown in FIG. 1.

FIG. 3A is an exploded view of the pain management user interface depicted in FIG. 3.

FIG. 4 is a block diagram illustrating a second embodiment of a control unit associated with a HHC in accordance with the present disclosure.

FIG. 5 is a side view of the gesture sense system of FIG. 4 detecting movement of an object.

FIG. 6 shows a touch-free user interface updating in response to a touch-free gesture.

FIG. 7 shows a touch-free user interface updating in response to a touch-free gesture.

FIG. 8 shows a touch-free user interface updating in response to a touch-free gesture.

FIG. 9 shows a touch-free user interface updating in response to a series of touch-free gestures.

FIG. 10 shows a diagram illustrating an example of a process for processing touch-free gestures with the control unit of FIG. 4.

### DESCRIPTION

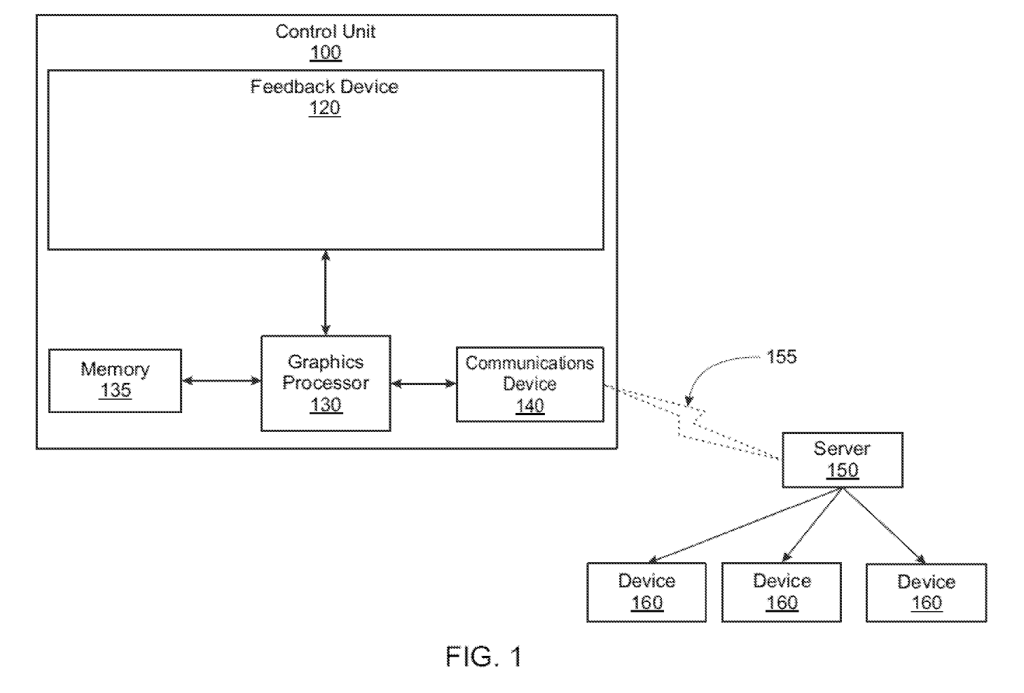

The various embodiments of the present disclosure and their advantages may be understood by referring to FIGS. 1 through 10 of the drawings. The elements of the drawings are not necessarily to scale, emphasis instead being placed upon illustrating the principles of preferred embodiments of the present disclosure. Throughout the drawings, like numerals are used for like and corresponding parts of the various drawings. The present disclosure may be provided in other specific forms and embodiments without departing from the essential characteristics as described herein. The embodiments described below are to be considered in all aspects as illustrative only and not restrictive in any manner.

As used herein, “processing workflow information” means executing instructions in response to one or more icons selected from a user interface displayed on a feedback device associated with a control unit, wherein the control unit or a server in communication with the control unit may be configured to process workflow information. Likewise, the following terms shall be construed in the following manner: “entering workflow information” means receiving input from a person, wherein input is related to workflow information and includes, without limitation, entering new workflow information or updating existing workflow information; and “communicating workflow information” means to distribute workflow information to devices on the communications network or directly to a person through a communications interface, such as a feedback device on a control unit. The term “transmitters” broadly refers to any device operable to transmit a light-based, sound-based, or heat-based signal. The term “receiver” broadly refers to devices operable to measure signals reflected off an object in addition to ambient light levels in a room or area. The term “device” broadly refers to tablets, smart phones, PDAs, personal computers, servers and any other like device now existing or hereafter developed. Finally, the term “pain status inquiry event” refers to verbal or non-verbal communications between a person (e.g. healthcare worker) and a patient regarding the level of pain, if any, that the patient may be experiencing.

In FIG. 1, one embodiment of a control unit (100) associated with a HHC system is shown. The control unit (100) includes a feedback device (120), a graphics processor (130), a memory (135) for storing program instructions and data, and a communications device (140). More specifically, the graphics processor (130) executes program instructions to display images on the feedback device (120), while the communications device (140) communicates with a server (150) over a communications network, such as a wireless computer network. Also, although not shown, the control unit (100) includes a second communications device in the form of a Radio Frequency (RF) radio configured to receive communications from a wearable tag (not shown) worn by a person that is within a predetermined proximity of the control unit (100). Further, the control unit (100) includes a sensor (also not shown), that is configured to detect a parameter indicating use of a hand hygiene dispenser associated with the control unit (100). It is understood that the use of sensors (i.e. mechanical switches, electro-mechanical switches, etc.) to detect use of a hand hygiene dispenser are within the ordinary skill of a person in the field of hand hygiene monitoring. As such, this aspect of the HHC system disclosed herein will not be discussed in detail.

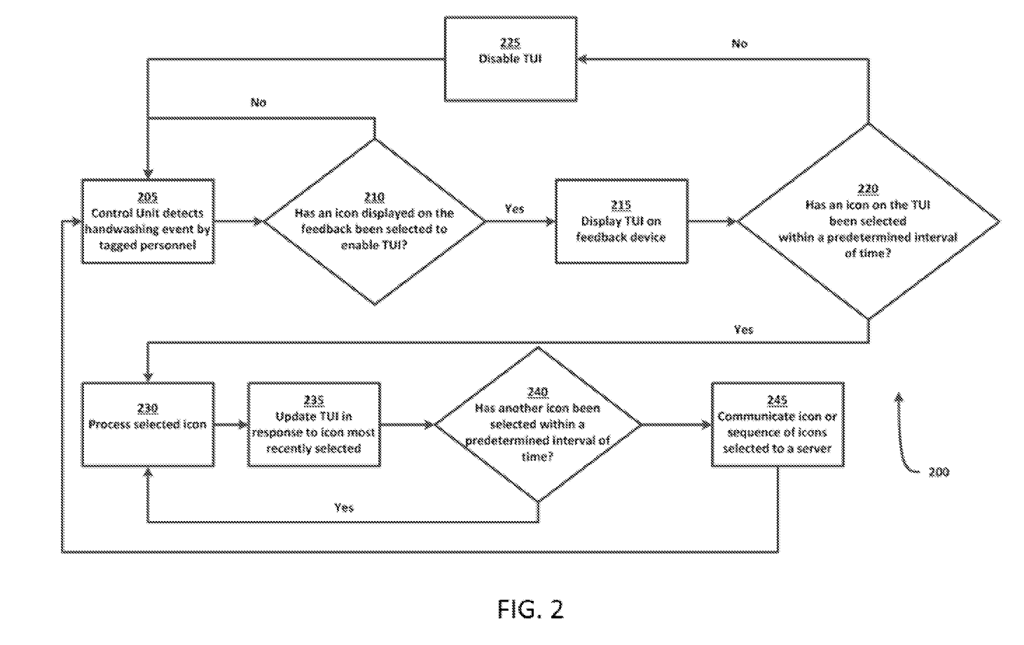

Referring to FIGS. 1 and 2 in combination, FIG. 2 is a control flow diagram illustrating one example of a process (200) for using the control unit (100) shown in FIG. 1 to, without limitation, communicate, enter, obtain, or update workflow information. The process (200) begins at step (205) when the control unit (110) detects use of a hand hygiene dispenser associated with the control unit (100) by a person wearing a wearable tag. At step (210), the control unit (110) enables use of a touch user interface (TUI), and control branches based upon actions of the person. If an icon is not selected, then control reverts to step (205). Conversely, if an icon is selected, then control branches to step (215) and the graphics processor (130) displays the TUI on the feedback device (120), wherein the TUI may be generic to everyone or user-specific based upon a role (i.e. nurse, doctor, environmental services, etc.) associated with the wearable tag.

At step (220), control branches again based upon actions of the person. If an icon on the TUI is not selected within a predetermined interval of time, then control branches to step (225) and the control unit (110) disables use of the TUI. Conversely, if an icon on the TUI is selected within the predetermined interval of time, then control branches to step (230) and, as a response to the icon most recently selected, the graphics processor (130) performs a function, macro, or generates new icons to display on the feedback device (120). At step (235), the graphics processor (130) updates the TUI in response to the icon most recently selected. At step (240), control branches again based upon actions of the person. If additional icons are selected, then iterations of steps (230) and (235) are executed until the predetermined interval of time passes without an icon of the TUI being selected. Once this condition is satisfied, control branches to step (245) and the communications device (140) communicates data over the communications network to the server (150), wherein the server (150) processes workflow information. Alternatively, in other embodiments, the control unit (100) may be programmed or configured to process workflow information.

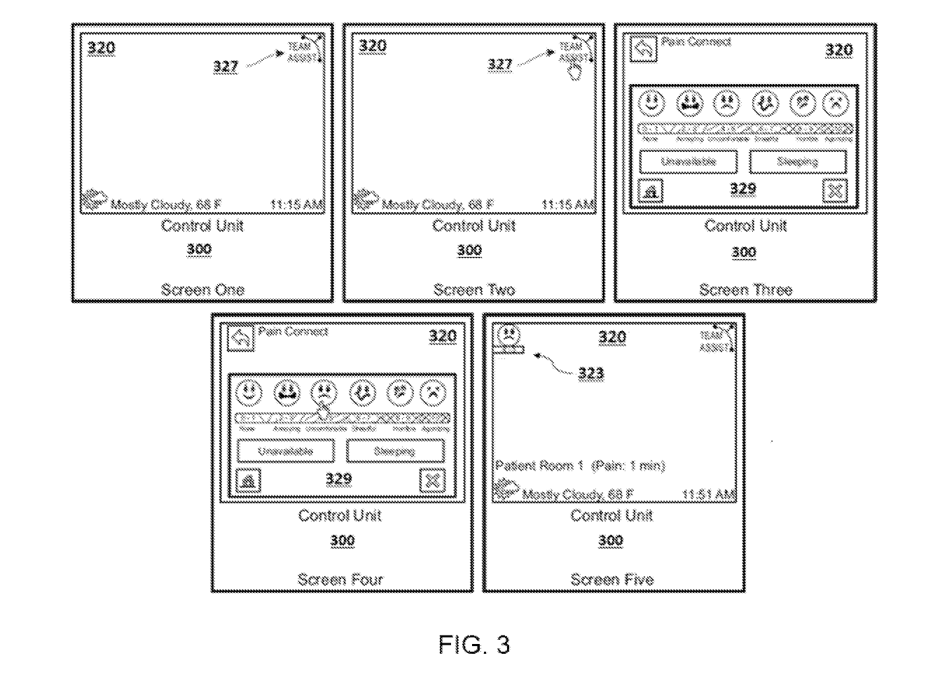

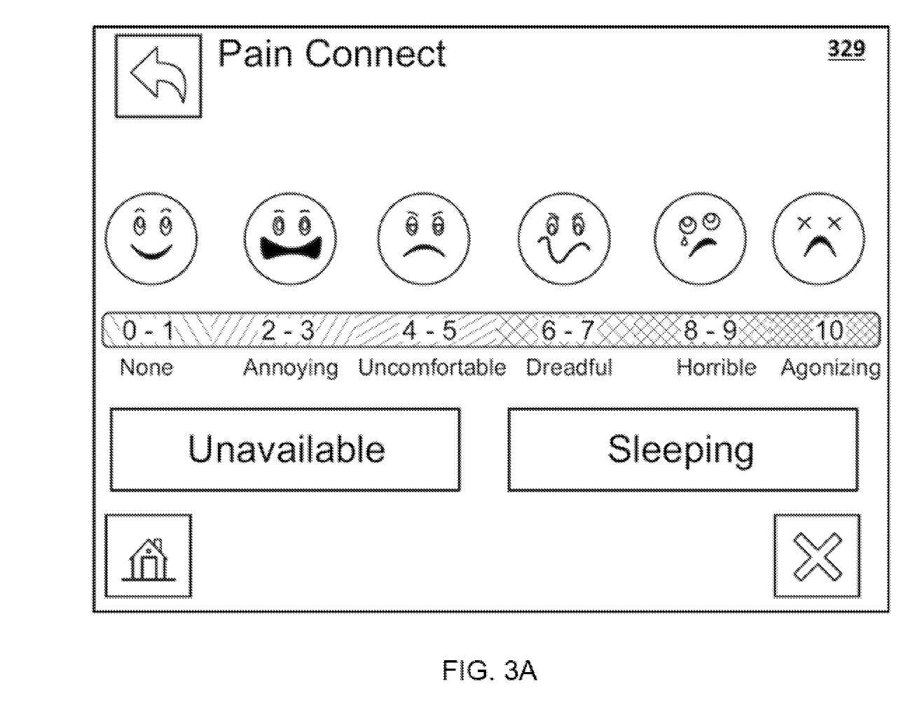

Referring now to FIG. 3, a person (e.g. a healthcare worker) may, via the selection of one or more icons displayed on a feedback device (320) of a control unit (300), enter or update a pain status indicator (323) for a patient resident in a room or area in which the control unit (300) is located. In preferred embodiments, the control unit (300) enables icon(s) only upon detecting a hand hygiene event (that is, dispensing of soap or hand sanitizer product from a hand hygiene dispenser (not shown) associated with the control unit (300)). Additionally, the control unit (300) may be configured to condition use of the icons even further based upon information included in wireless transmissions sent from a wearable tag (not shown) worn by the person. In one embodiment, the control unit (300) limits use of the icons based upon a healthcare provider role (e.g., nurse, physician, etc.) that is assigned to each wearable tag. More specifically, the healthcare provider role is a unique identifier that is stored in memory associated with a wearable tag and is included in a data packet sent from the tag to the control unit over a wireless network. Still further, once enabled, a person can, via the selection of one or more icons, enter or update a patient status indicator (323) for a patient, wherein the pain status indicator (323) is, at least in part, a function of the patient's response(s) during a pain status inquiry event.

As shown in FIG. 3, a user (not shown) enters a pain status indicator (323) for a patient by selecting a plurality of icons displayed on the feedback device (320). More specifically, the user selects a first icon (327) which, upon being selected, prompts the control unit (300) to display and enable use of a pain management user-interface (329), which is also depicted in FIG. 3A. In the embodiment shown, each of the icons included in the pain management user-interface (329) correspond to one or more values on a numerical scale that is representative of the varying degrees of pain that a patient may be experiencing when the user performs a pain status inquiry event. Further, the pain management interface (329) also includes icons to account for instances where the user was unable to perform the pain status inquiry event due to the patient being asleep or otherwise unavailable. Further, upon performing the pain status inquiry event and selecting one of the icons on the pain management interface (329), the control unit (300) populates the feedback device (320) with a pain status indicator (323).

The control unit (300) also transmits results (that is, the pain status indicator) of the pain status inquiry event to a server (not shown) via a wired or wireless network, wherein the server assigns a timestamp for the event and stores the pain status indicator in memory associated with the server. It is understood that the aforementioned results may be the numerical value or range of numerical values assigned to the pain status indicator, or a unique code associated with the pain status indicator. Alternatively, the control unit (300) may be programmed to assign the timestamp and store results locally on a memory associated with the control unit (300). Still further, the control unit (300) may be programmed to transmit results from memory to the server over a wired or wireless network.

A report based on results may be generated by authorized personnel and viewed on a device, such as without limitation, a laptop or desktop computer, smartphone, PDA, or any other like device now existing or developed hereafter. More specifically, the report may include, without limitation, the number of pain status inquiry events performed over a predetermined interval of time (e.g., interval of time spanning a patient's admission to said patient's discharge) along with the pain status indicator recorded for each event. Further, the report may also include the number of instances where a pain status inquiry event proved unsuccessful due to the patient being asleep or otherwise unavailable. Still further, the report may include the name of a healthcare worker associated with each pain status inquiry event. The report may be compared against Hospital Consumer Assessment of Healthcare Providers and Systems (HCAHPS) scores so as to identify any lapses in implementing a hospital's pain management protocol. Still further, nurse managers may use the report to educate those individuals (that is, healthcare workers) that do not adhere to an established protocol regarding pain status inquiry events.

The control unit (300) may be programmed to monitor a time lapse since a pain status indicator (323) was entered or most recently updated. As follows, if the time lapse exceeds a predetermined value, the control unit (300) may be programmed to generate a notification on the feedback device (320), wherein the notification (e.g., audio or visual notification) prompts healthcare workers within a predetermined proximity of the control unit (300) to perform a pain status inquiry event.

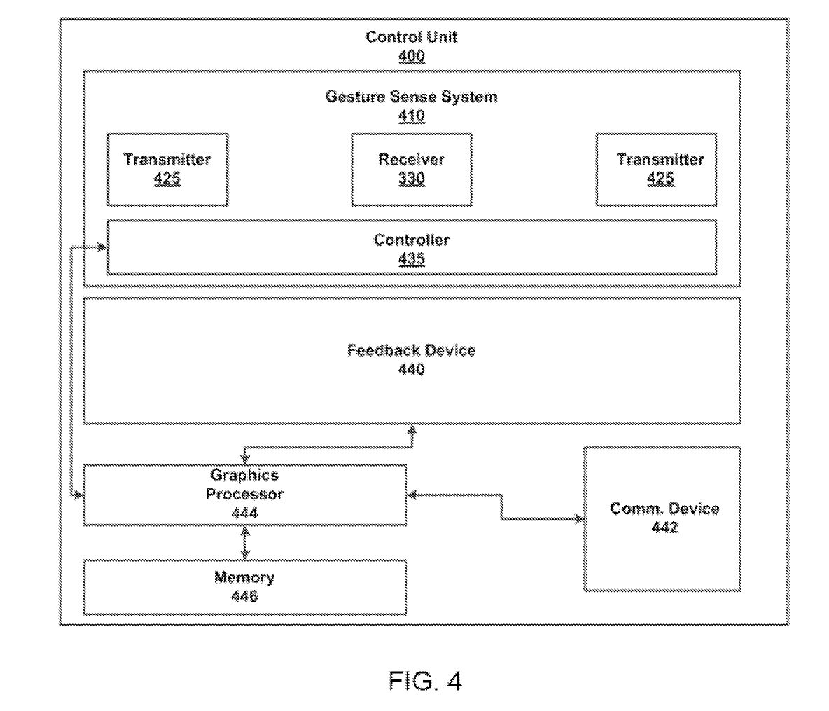

FIG. 4 depicts a block diagram for one embodiment of a control unit (400) associated with a HHC system. The control unit (400) includes a gesture-sense system (410), a feedback device (440), a communications device (442), a graphics processor (444), and a memory (446). The gesture-sense system (410) includes a plurality of transmitters (420), (425), a receiver (430), and a controller (435).

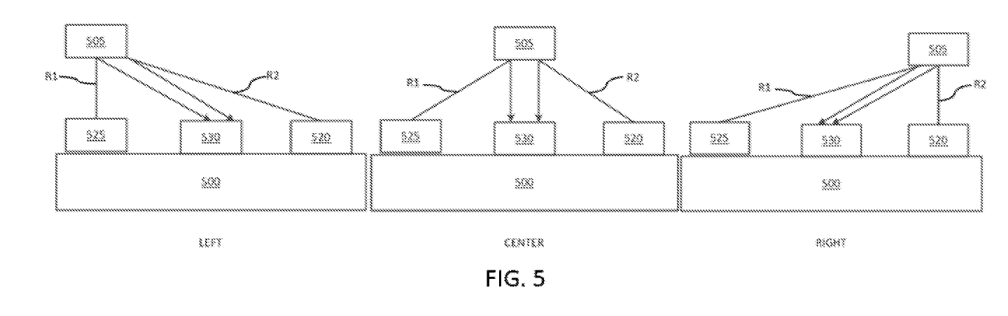

Referring now to FIG. 5, a side view of the gesture sense system (510) is shown. In this embodiment, the receiver (530) and transmitters (520), (525) are independently activated, and the receiver (530) detects reflected signals R1 and R2, respectively from an object (505). The amplitude of the reflected light signals R1 and R2 are measured by the receiver (530). It is assumed that the strength of the reflected signal represents the distance of the object from the gesture sense system (510). The receiver (530) converts reflectance measurements to digital values that are stored by the controller (535), and measurements are repeated under the control of the controller (535) at time intervals, fixed or variable. The measurements taken at each time interval are compared to determine position of the object in the X-axis, and the measurements between time intervals are compared by the controller (535) to determine motion of the object or lack thereof, which can be interpreted as a touch-free gesture.

By recording the ratio of R1 to R2 as well as the amplitude of R1 and R2, the controller can detect motion of the object (505) towards or away from the gesture sense system (510). For example, if the ratio of R1 to R2 remains substantially the same over a series of measurements, but the amplitude measured for R1 and R2 increase or decrease, then the controller (335) interprets this as motion towards the gesture sense system (510) or away from the gesture sense system (510), respectively. As follows, motion of the object (505) towards the gesture sense system (510) is interpreted by the controller (535) as an enter gesture used to select an icon on a menu of icons displayed on the feedback device (540). Further, as discussed in more detail below, in addition to detecting motion in the Z-axis, the gesture sense system (510) is operable to detect motion of the object (505) in both the X and Y-axis.

As an example, a positive motion in the X-axis can be interpreted as a right swipe, while a negative motion in the X-axis can be interpreted as a left swipe. Likewise, positive motion in the Z-axis can be interpreted as an enter gesture, and, although not shown, it is understood that one or more of the transmitters (520), (525) may be positioned along the Y-axis, rather than along the X axis, to detect vertical motion of an object. The rate of movement may also be measured. For example, a higher rate of movement may correspond to a fast scroll while a slower rate of movement may correspond to a slow scroll. Further, once the controller (535) correlates the object's motion to one of a plurality of predefined touch-free gestures, the controller (535) sends a command to the graphics processor (544) to execute a function, macro, or modify the list of icons on a touch-free menu, a process discussed in more detail below.

Alternatively, in another embodiment, the control unit may be equipped with a capture device in the form of a camera, which may be used to visually monitor motion of a user. Further, the control unit may be programmed (i.e. image or motion recognition software) to interpret motion of the user as controls that can be used to affect a touch-free menu displayed on a feedback device associated with the control unit. As such, a user may use her movements to navigate to or select one or more icons on the touch-free menu. In this particular embodiment, the control unit is programmed to enable the camera only after detecting use of a hand hygiene dispenser associated with the control unit. In other words, the user must comply with hand hygiene protocols before gaining access to the touch-free menu.

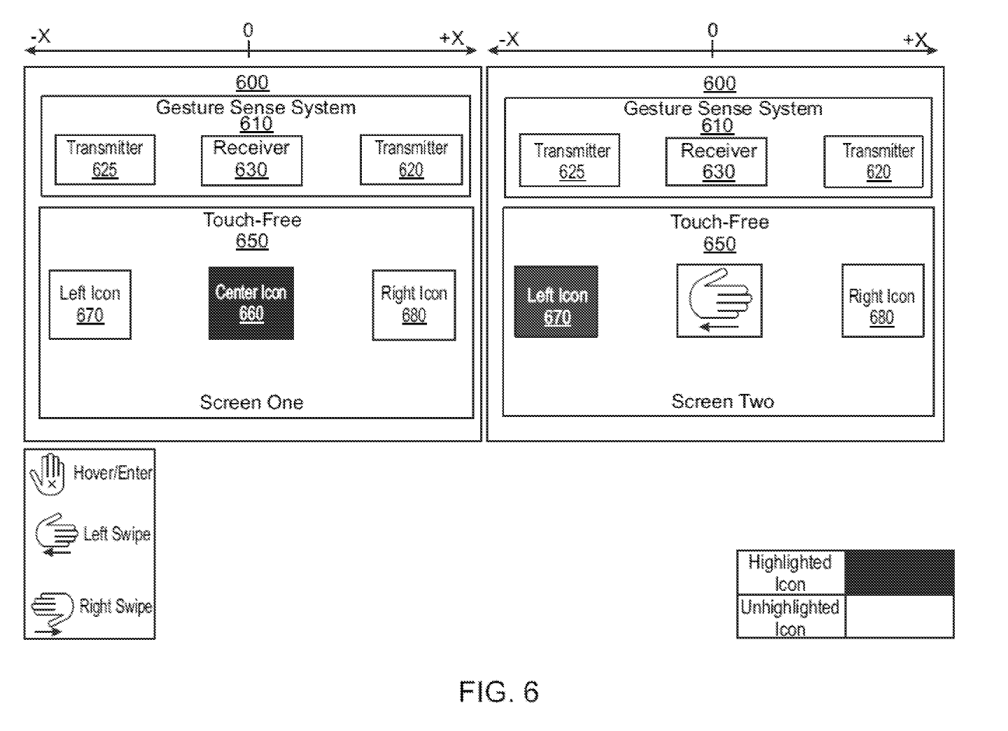

Referring now to FIG. 6, if the receiver (630) records a series of position measurements of +X, 0, and −X sequentially in time for a person's hand, the controller (635) recognizes the right to left motion of the person's hand as a left swipe, which the controller (635) interprets as a command to scroll left on a touch-free menu (650) displayed on the feedback device (640). As follows, the controller (635) sends a command to the graphics processor (644) to shift a selection indicator from a center icon (660) to a left icon (670).

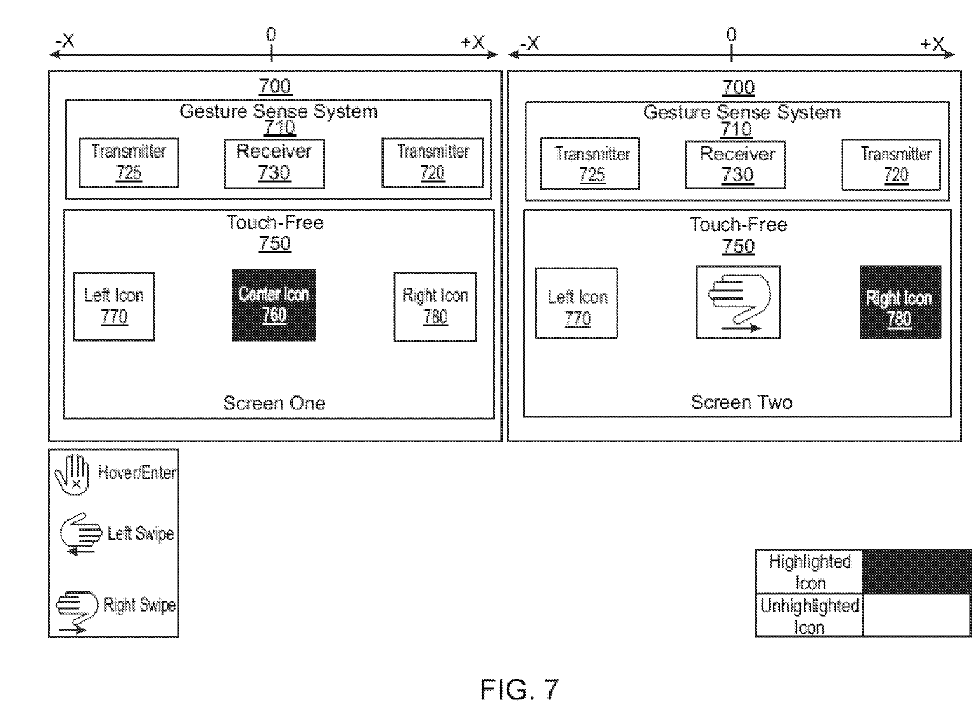

Similarly, as shown in FIG. 7, if the receiver (730) records a series of position measurements of −X, 0, +X, the controller (735) recognizes the left to right motion as a right swipe, which the controller (735) interprets as a command to scroll right on the touch-free menu (750). As follows, the controller (735) sends a message to the graphics processor (744) to shift the selection indicator from the center icon (760) to a right icon (780).

Referring again to FIG. 4, in addition to monitoring motion of an object in the x-axis, distance of the object from the control unit (400) may be determined using the gesture sense system (410). If the magnitude of reflectance measurements increase over time, the controller (435) interprets the increase in magnitude as the person's hand moving towards the gesture sense system (410). Likewise, if the magnitude of reflectance measurements decrease over time, the controller (435) interprets the decrease as the person's hand moving away from the gesture sense system (410).

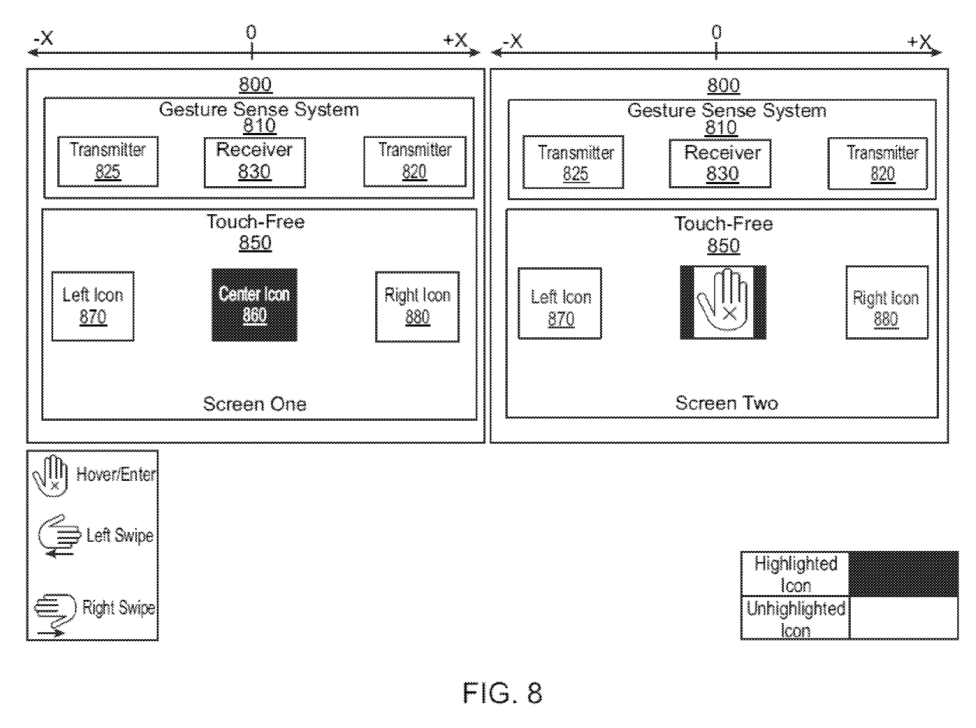

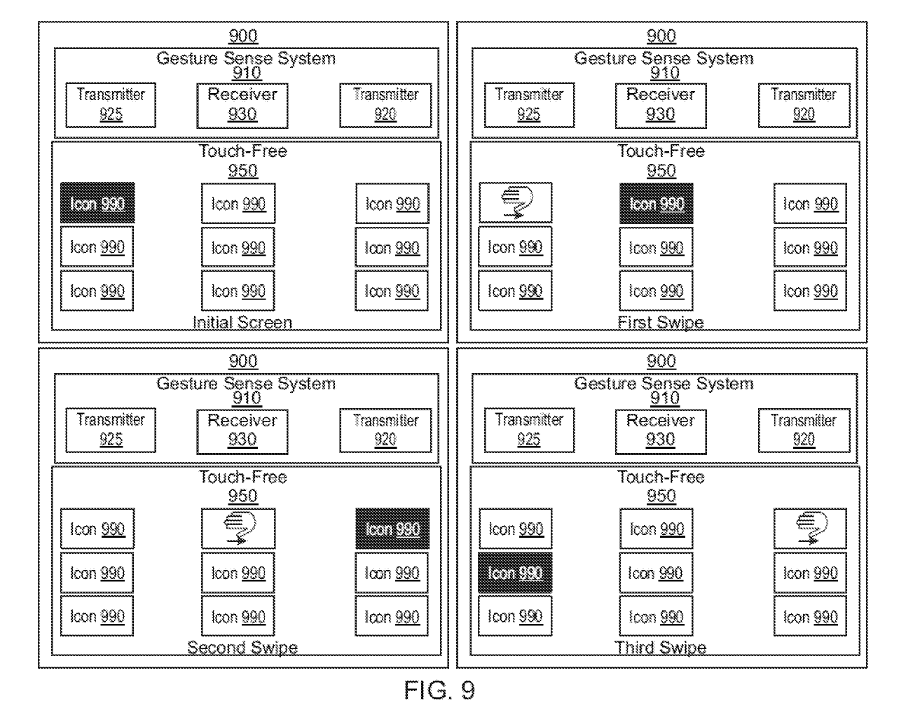

As shown in FIG. 8, when the controller (835) interprets an object's movement towards the control unit (800) as an enter gesture, the controller (835) sends a command to the graphics processor (844) to select whatever icon the selection indicator is currently on, which in the embodiment shown is the center icon (860). Additionally, whenever an icon is selected, the graphics processor (844) performs a function, macro, or modifies the list of icons on the touch-free menu (850) in response to the icon most recently selected. In an effort to reduce the amount of time a person must wait for the touch-free menu (850) to update in response to an icon they selected, lists of icons may be stored in memory (846) and accessed directly by the graphics processor (844). Further, FIG. 9 demonstrates the ability to navigate through multiple rows of icons (990) via a series of a touch-free gestures.

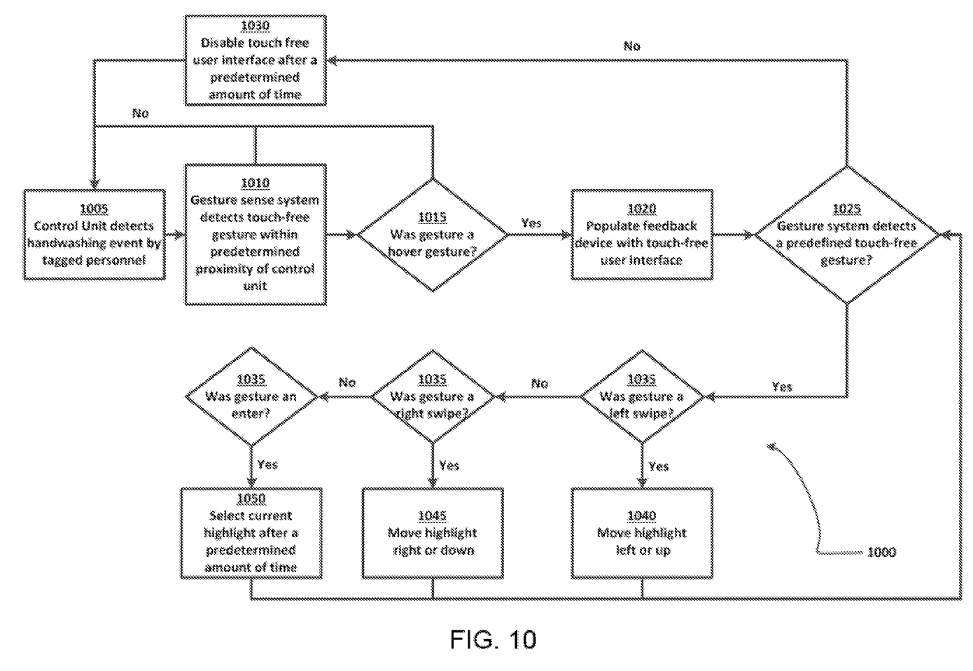

Referring now to FIGS. 4 and 10 in combination, FIG. 10 is a control flow diagram illustrating one example of a process (1000) for using the control unit (400) shown in FIG. 4 to, without limitation, communicate, enter, obtain, or update workflow information. At step (1005), the process (100) begins when the control unit (400) detects use of a hand hygiene dispenser associated with the control unit (400) by a person wearing a wearable tag. Next, at step (1010), control branches based upon actions of the person. If the gesture sense system (410) does not detect a touch-free gesture, then control branches to step (1005). Conversely, if the gesture sense system (410) detects a touch-free gesture, then control branches to step (1015).

At step (1015), if the gesture matches one of a plurality of predefined gestures, then control proceeds to step (1020) and the controller (435) sends a message to the graphics processor (444) to display the touch-free menu (1050) on the feedback device (440). Next, at step (1025), control branches based upon actions of the person. If a second touch-free gesture is not detected by the gesture sense system (410), control branches to step (1030) and the control unit (400) disables use of the touch-free menu (450) after a predetermined interval of time. Conversely, if a second touch-free gesture is detected, then control branches to step (1035).

At step (1035), control branches again according to which predefined touch-free gesture the controller (435) matches with the second touch-free gesture. If the second touch-free gesture is a left swipe, then the controller (435) sends a message to the graphics processor (444) at step (1040) to shift a selection indicator left or up on the touch-free menu. If the second touch-free gesture is a right swipe, then the controller (435) sends a message to the graphics processor (444) at step (1045) to shift the selection indicator right or down. If the second touch-free gesture is an enter gesture, then the controller (435) sends a message to the graphics processor (444) at step (1050) to select whatever icon is currently highlighted by the selection indicator. It is understood that any combination of steps (1040), (1045), and (1050) may occur until a predetermined interval of time passes during which the gesture-sense system (410) is unable to detect a touch-free gesture that matches one of the predefined gestures in step (1035). When this end condition is met, control reverts to step (1030).

The use of the terms “a” and “an” and “the” and similar referents in the context of describing the present disclosure (especially in the context of the following claims) are to be construed to cover both the singular and the plural, unless otherwise indicated herein or clearly contradicted by the context. The use of any and all examples, or exemplary language (e.g., “such as”) provided herein, is intended merely to better illuminate the present disclosure and does not pose a limitation on the scope of the disclosure unless otherwise claimed. Also, no language in the specification should be construed as indicating any non-claimed element as essential to practicing the present disclosure.

Further, one of ordinary skill in the art will recognize that a variety of approaches for communicating workflow information with a HHC system may be employed without departing from the teachings of the present disclosure. Therefore, the foregoing description is considered in all respects to be illustrative and not restrictive.

1. A method for using a hand hygiene compliance (HHC) system to record pain status of a patient resident in a room of a medical facility, the method comprising:
detecting use of a hand hygiene dispenser by a person, the hand hygiene dispenser located in or within a predetermined proximity of the room and associated with a control unit configured to detect a parameter indicating use of the dispenser;
displaying a user-interface on a feedback device of the control unit, the control unit displaying the user-interface in response to detecting use of the hand hygiene dispenser;
enabling use of the user-interface in order to allow the person to enter or update pain status of the patient, the control unit enabling use of the user-interface in response to detecting use of the hand hygiene dispenser; and
receiving a pain status indicator via a selection of one or more icons on the user-interface.

2. The method of claim 1, further comprising displaying the pain status indicator on the feedback device.

3. The method of claim 1, further comprising communicating the pain status indicator to a server over a wired or wireless communications link.

4. The method of claim 3, further comprising storing the pain status indicator on a database associated with the server.

5. The method of claim 1, further comprising monitoring time lapse since receiving the pain status indicator.

6. The method of claim 5, further comprising generating a notification when said time lapse exceeds a predetermined interval of time.

7. The method of claim 6, further comprising displaying the notification on the feedback device.

8. The method of claim 7, wherein the notification displayed on the feedback device is an audible notification.

9. The method of claim 7, wherein the notification displayed on the feedback device is a visual notification.

10. The method of claim 1, wherein the user-interface is a touch-screen.

11. The method of claim 1, wherein the user-interface is touch-free.

12. The method of claim 11, wherein the control unit includes a gesture sense system to detect touch-free gestures made by the person in order to communicate the selection of one or more icons on the user-interface.

13. A hand hygiene compliance (HHC) system, the HHC system comprising:
a control unit associated with a hand hygiene dispenser located in or within a predetermined proximity of a room in which a patient is resident, the control unit further comprising a sensor capable of detecting a parameter indicating use of the of the hand hygiene dispenser; and
a feedback device capable of displaying a user-interface each time the sensor detects use of the hand hygiene dispenser, the user-interface including one or more icons that allow a user to enter or update a pain status indicator for a patient.

14. The HHC system of claim 13, further comprising a server in communication with the control unit via a wired or wireless communications link, the server operable to store the pain status indicator.

15. The HHC system of claim 13, wherein the user-interface is a touch-screen.

16. The HHC system of claim 13, wherein the user-interface is touch-free.

17. The HHC system of claim 16, the control unit further comprising a gesture sense system to detect touch-free gestures made by the person in order to select said one or more icons that allow the person to enter or update the pain status indicator.
